(19) United States
(12) Patent Application Publication
(10) Pub. No.: US 2007/0254159 A1
(43) Pub. Date: Nov. 1, 2007

(54) COATING COMPOSITIONS EXHIBITING CORROSION RESISTANCE PROPERTIES, RELATED COATED SUBSTRATES, AND METHODS

(75) Inventors: John R. Schneider, Glenshaw, PA (US); Cheng-Hung Hung, Wexford, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/766,258

(22) Filed: Jun. 21, 2007

Related U.S. Application Data
(63) Continuation-in-part of application No. 11/213,136, filed on Aug. 26, 2005.

(51) Int. Cl. B32B 9/04

(52) U.S. Cl. 428/411.1; 106/14.05; 106/14.44

(57) ABSTRACT

Coating compositions are disclosed that include corrosion resisting particles. Also disclosed are methods for making such coating compositions and substrates at least partially coated with a coating deposited from such a coating composition and multi-component composite coatings, wherein at least one coating layer is deposited from such a coating composition.

### CROSS-REFERENCE TO RELATED APPLICATION

This application is a continuation-in-part of U.S. patent application Ser. No. 11/213,136, filed Aug. 26, 2005, which is incorporated herein by reference.

### FIELD OF THE INVENTION

The present invention relates to coating compositions that comprise corrosion resisting particles such that the coating compositions exhibit corrosion resistance properties. The present invention also relates to substrates at least partially coated with a coating deposited from such a composition and multi-component composite coatings, wherein at least one coating layer is deposited from such a coating composition.

### BACKGROUND OF THE INVENTION

Coating systems that are deposited onto a substrate and cured, such as “color-plus-clear” and “monocoat” coating systems, can be subject to damage from the environment. For example, corrosion of a coated metallic substrate can occur as the substrate is exposed to oxygen and water present in the atmosphere. As a result, a “primer” coating layer is often used to protect the substrate from corrosion. The primer layer is often applied directly to a bare or pretreated metallic substrate. In some cases, particularly where the primer layer is to be applied over a bare metallic substrate, the primer layer is deposited from a composition that includes a material, such as an acid, such as phosphoric acid, which enhances the adhesion of the primer layer to the substrate. Such primers are sometimes known as “etch primers”.

As indicated, in some cases metallic substrates are “pretreated” before a primer coating layer is applied (if such a primer coating is used). Such “pretreatments” often involve the application of a phosphate conversion coating, followed by a rinse, prior to the application of a protective or decorative coating. The pretreatment often acts to passivate the metal substrate and promotes corrosion resistance.

Historically, corrosion resistant “primer” coatings and metal pretreatments have utilized chromium compounds and/or other heavy metals, such as lead, to achieve a desired level of corrosion resistance and adhesion to subsequently applied coatings. For example, metal pretreatments often utilize phosphate conversion coating compositions that contain heavy metals, such as nickel, and post-rinses that contain chrome. In addition, the compositions used to produce a corrosion resistant “primer” coating often contain chromium compounds. An example of such a primer composition is disclosed in U.S. Pat. No. 4,069,187. The use of chromium and/or other heavy metals, however, results in the production of waste streams that pose environmental concerns and disposal issues.

More recently, efforts have been made to reduce or eliminate the use of chromium and/or other heavy metals. As a result, coating compositions have been developed that contain other materials added to inhibit corrosion. These materials have included, for example, zinc phosphate, iron phosphate, zinc molybdate, and calcium molybdate particles, among others, and typically comprise particles having a particle size of approximately a micron or larger. The corrosion resistance capability of such compositions, however, has been inferior to their chrome containing counterparts.

As a result, it would be desirable to provide coating compositions that are substantially free of chromium and/or other heavy metals, but which exhibit corrosion resistance properties that are, in at least some cases, superior to a similar non-chrome containing composition.

### SUMMARY OF THE INVENTION

In certain respects, the present invention is directed to coating compositions that comprise: (a) a film-forming resin, and (b) ultrafine corrosion resisting particles comprising ultrafine, unsaturated transition metal oxide particles deposited on and/or within an ultrafine support.

In some respects, the present invention is directed to methods for making a coating composition. These methods comprise combining ultrafine unsaturated transition metal oxide particles with a film-forming resin, wherein the particles are not coated with a layer of organic molecules prior to the combining step.

### BRIEF DESCRIPTION OF THE DRAWINGS

FIGS. 1A and 1B are flowcharts depicting the steps of certain methods for making corrosion resisting particles suitable for use in certain embodiments of the present invention;

FIGS. 2A and 2B are schematic views of apparatus for producing corrosion resisting particles suitable for use in certain embodiments of the present invention; and

FIG. 3 is a detailed perspective view of a plurality of quench stream injection ports in accordance with certain embodiments of the present invention.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. For example, and without limitation, this application refers to coating compositions that, in certain embodiments, comprise a “film-forming resin.” Such references to “a film-forming resin” is meant to encompass coating compositions comprising one film-forming resin as well as coating compositions that comprise a mixture of two or more film-forming resins. In addition, in this application, the use of “or” means “and/or” unless specifically stated otherwise, even though “and/or” may be explicitly used in certain instances.

In certain embodiments, the present invention is directed to coating compositions that are substantially free of chromium containing material. In other embodiments, the coating compositions of the present invention are completely free of such a material. As used herein, the term “substantially free” means that the material being discussed is present in the composition, if at all, as an incidental impurity. In other words, the material does not affect the properties of the composition. This means that, in certain embodiments of the present invention, the coating composition contains less than 2 weight percent of chromium containing material or, in some cases, less than 0.05 weight percent of chromium containing material, wherein such weight percents are based on the total weight of the composition. As used herein, the term “completely free” means that the material is not present in the composition at all. Thus, certain embodiments of the coating compositions of the present invention contain no chromium-containing material. As used herein, the term “chromium containing material” refers to materials that include a chromium trioxide group, CrO₃. Non-limiting examples of such materials include chromic acid, chromium trioxide, chromic acid anhydride, dichromate salts, such as ammonium dichromate, sodium dichromate, potassium dichromate, and calcium, barium, magnesium, zinc, cadmium, and strontium dichromate.

Certain embodiments of the coating compositions of the present invention are substantially free of other undesirable materials, including heavy metals, such as lead and nickel. In certain embodiments, the coating compositions of the present invention are completely free of such materials.

As indicated, the coating compositions of the present invention comprise “corrosion resisting particles.” As used herein, the term “corrosion resisting particles” refers to particles which, when included in a coating composition that is deposited upon a substrate, act to provide a coating that resists or, in some cases, even prevents, the alteration or degradation of the substrate, such as by a chemical or electrochemical oxidizing process, including rust in iron containing substrates and degradative oxides in aluminum substrates.

In certain embodiments, the present invention is directed to coating compositions that comprise corrosion resisting particles comprising an unsaturated transition metal oxide. As used herein, the term “transition metal” refers to the metals found in groups 3 to 12 of the Periodic Table of Elements that have variable valence, meaning that they have more than one possible oxidation-or valence-state. Examples of elements that are transition metals, for purposes of the present invention, are Ti, V, Mn, Fe, Co, Ni, Cu, Nb, Tc, Pd, Re, Os, Ir, Pt, and Au. As used herein, the term “unsaturated transition metal oxide” refers to transition metals oxides in which the transition metal oxide has an oxygen deficiency in its crystalline structure, i.e., it is not at its highest valence, i.e., oxidation state. For example, and without limitation, Mn has valences of +2, +3, +4, and +7. Therefore, Mn at valences of +2, +3 or +4 is not at its highest valence. Examples of unsaturated transition metal oxides, which are suitable for use in the coating compositions of the present invention are TiO, Ti₂O₃, VO, V₂O₃, VO₂, MnO, Mn₂O₃, MnO₂, FeO, CoO, NiO, Cu₂O, Nb₂O₃, TcO₂, TcO₃, PdO, ReO₂, ReO₃, Ir₂O₃, PtO, Au₂O, and combinations thereof.

In certain embodiments, the unsaturated transition metal oxide particles described above are stoichiometric materials. As used herein, the term “stoichiometric material” refers to materials that have a composition having stoichiometric bonding between two or more elements as described, for example, in U.S. Pat. No. 6,602,595 at col. 9, lines 20-43.

In certain embodiments, the corrosion resisting particles utilized in the coating compositions of the present invention comprise ultrafine unsaturated transition metal oxide particles, deposited on and/or within an ultrafine support. As used herein, the term “support” refers to a material upon which or in which another material is carried. In certain embodiments, the corrosion resisting particles comprise an ultrafine silica support, such as, for example, amorphous silica, fumed silica, and/or precipitated silica. In certain embodiments, the support itself is an ultrafine particle having, for example, an average primary particle size of no more than 50 nanometers, such as no more than 20 nanometers. In certain embodiments, the ultrafine unsaturated transition metal oxide particles deposited on and/or within the support have an average primary particle size of no more than 20 nanometers, such as no more than 10 nanometers or, in some cases, no more than 5 nanometers.

In certain embodiments, the ultrafine corrosion resisting particles utilized in the coating compositions of the present invention are not, at least prior to their incorporation into the coating composition, coated with a layer of organic molecules.

In certain embodiments, such corrosion resisting particles provide desirable protection against both edge corrosion and scribe-corrosion on the surface of a substrate that is exposed to anodic dissolution.

As indicated, the previously described corrosion resisting particles are ultrafine particles. As used herein, the term “ultrafine” refers to particles that have an average B.E.T. specific surface area of at least 10 square meters per gram, such as 30 to 500 square meters per gram, or, in some cases, 80 to 350 square meters per gram or 200 to 350 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

In certain embodiments, the coating compositions of the present invention comprise corrosion resisting particles of the type previously described having a calculated equivalent spherical diameter of no more than 200 nanometers, such as no more than 100 nanometers, or, in certain embodiments, 5 to 50 nanometers. As will be understood by those skilled in the art, a calculated equivalent spherical diameter can be determined from the B.E.T. specific surface area according to the following equation:
Diameter(nanometers)=6000/[BET(m²/g)*ρ(grams/cm³)]

Certain embodiments of the coating compositions of the present invention comprise corrosion resisting particles of the type previously described having an average primary particle size of no more than 100 nanometers, such as no more than 50 nanometers, or, in certain embodiments, no more than 20 nanometers, as determined by visually examining a micrograph of a transmission electron microscopy (“TEM”) image, measuring the diameter of the particles in the image, and calculating the average primary particle size of the measured particles based on magnification of the TEM image. One of ordinary skill in the art will understand how to prepare such a TEM image and determine the primary particle size based on the magnification and the Examples contained herein illustrate a suitable method for preparing a TEM image. The primary particle size of a particle refers to the smallest diameter sphere that will completely enclose the particle. As used herein, the term “primary particle size” refers to the size of an individual particle as opposed to an agglomeration of two or more individual particles.

In certain embodiments, the corrosion resisting particles have an affinity for the medium of the composition sufficient to keep the particles suspended therein. In these embodiments, the affinity of the particles for the medium is greater than the affinity of the particles for each other, thereby reducing or eliminating agglomeration of the particles within the medium.

The shape (or morphology) of the previously described corrosion resisting particles can vary. For example, generally spherical morphologies can be used, as well as particles that are cubic, platy, or acicular (elongated or fibrous).

In addition to the previously described corrosion resisting particles, the coating compositions of the present invention may also include other corrosion resisting particles. For example, in certain embodiments, the coating compositions of the present invention also include corrosion resisting particles comprising ultrafine particles comprising an inorganic oxide, in some embodiments a plurality of inorganic oxides; corrosion resisting particles comprising an inorganic oxide network comprising one or more inorganic oxide; chemically modified particles having an average primary particle size of no more than 500 nanometers; and/or corrosion resisting particles comprising an inorganic oxide in combination with a pH buffering agent, such as, for example, a borate. Corrosion resisting particles of these types, and suitable methods for their production, are described in U.S. patent application Ser. No. 11/384,970 at [0021] to [0080], the cited portion of which being incorporated herein by reference.

The previously described ultrafine corrosion resisting particles that are included in certain embodiments of the coating compositions of the present invention may be prepared by various methods, including gas phase synthesis processes, such as, for example, flame pyrolysis, hot walled reactor, chemical vapor synthesis, among other methods. In certain embodiments, however, such particles are prepared by reacting together one or more solid or liquid precursors in a fast quench plasma system. In certain embodiments, the particles may be formed in such a system by: (a) introducing one or more materials into a plasma chamber; (b) heating the material(s) in the high temperature chamber, yielding a gaseous product stream; (c) quenching the gaseous product stream, thereby producing ultrafine particles, and (d) collecting the ultrafine particles. Certain suitable fast quench plasma systems and methods for their use are described in U.S. Pat. Nos. 5,749,937, 5,935,293, and RE37,853 E, which are incorporated herein by reference.

One particular process of preparing ultrafine corrosion resisting particles suitable for use in certain embodiments of the coating compositions of the present invention comprises: (a) introducing one or more liquid and/or solid precursors into a high temperature chamber; (b) rapidly heating the precursor(s) by means of a plasma to yield a gaseous product stream; (c) passing the gaseous product stream through a restrictive convergent-divergent nozzle to effect rapid cooling and/or utilizing an alternative cooling method, such as a cool surface or quenching stream; and (d) condensing the gaseous product stream to yield ultrafine particles. In certain embodiments, such a process comprises: (a) introducing the precursor(s) into one axial end of a plasma chamber; (b) rapidly heating the precursor(s) by means of a plasma as they flow through the plasma chamber, yielding a gaseous product stream; (c) passing the gaseous product stream through a restrictive convergent-divergent nozzle arranged coaxially within the end of the reaction chamber; and (d) subsequently cooling and slowing the velocity of the desired end product exiting from the nozzle, yielding ultrafine particles.

In certain embodiments, the ultrafine corrosion resisting particles present in the coating compositions of the present invention are produced by a method comprising: (a) introducing one or more precursors into a plasma chamber; (b) heating the precursor(s) by means of a plasma as the precursor flow through a plasma chamber, yielding a gaseous product stream; (c) contacting the gaseous product stream with a plurality of quench streams injected into the plasma chamber through a plurality of quench stream injection ports, wherein the quench streams are injected at flow rates and injection angles that result in impingement of the quench stream with each other within the gaseous product stream, thereby producing ultrafine particles; (d) passing the ultrafine particles through a converging member; and (e) collecting the ultrafine particles.

In certain embodiments, the ultrafine corrosion resisting particles present in the coating compositions of the present invention are produced by a method comprising: (a) introducing one or more precursor(s) into a plasma chamber; (b) heating the precursor(s) by means of a plasma as the precursor flow through a plasma chamber, yielding a gaseous product stream; (c) passing the gaseous product stream through a converging member, and then (d) contacting the gaseous product stream with a plurality of quench streams injected into the plasma chamber through a plurality of quench stream injection ports, wherein the quench streams are injected at flow rates and injection angles that result in impingement of the quench stream with each other within the gaseous product stream, thereby producing ultrafine particles; and (e) collecting the ultrafine particles.

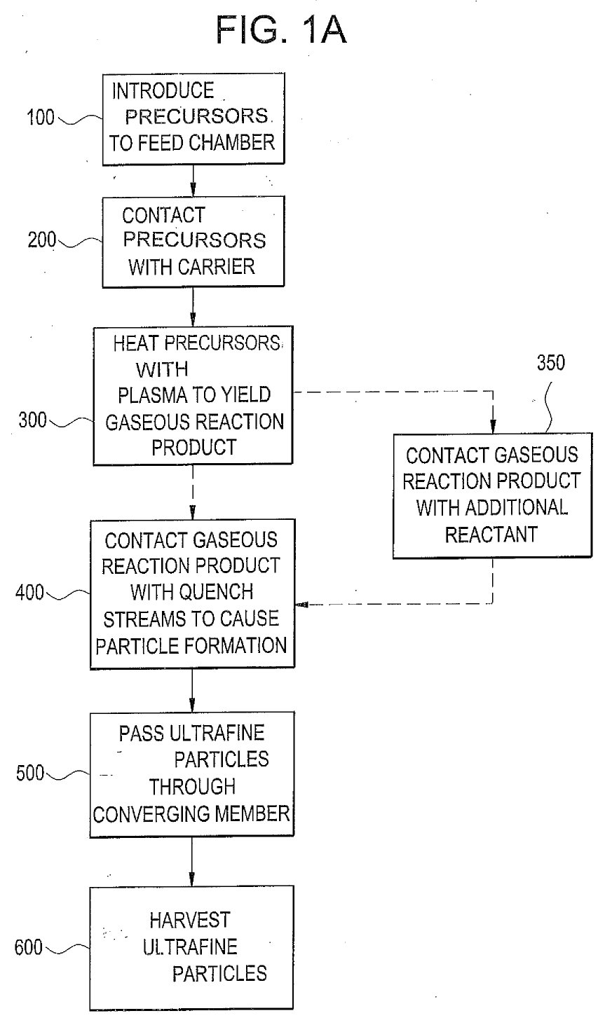

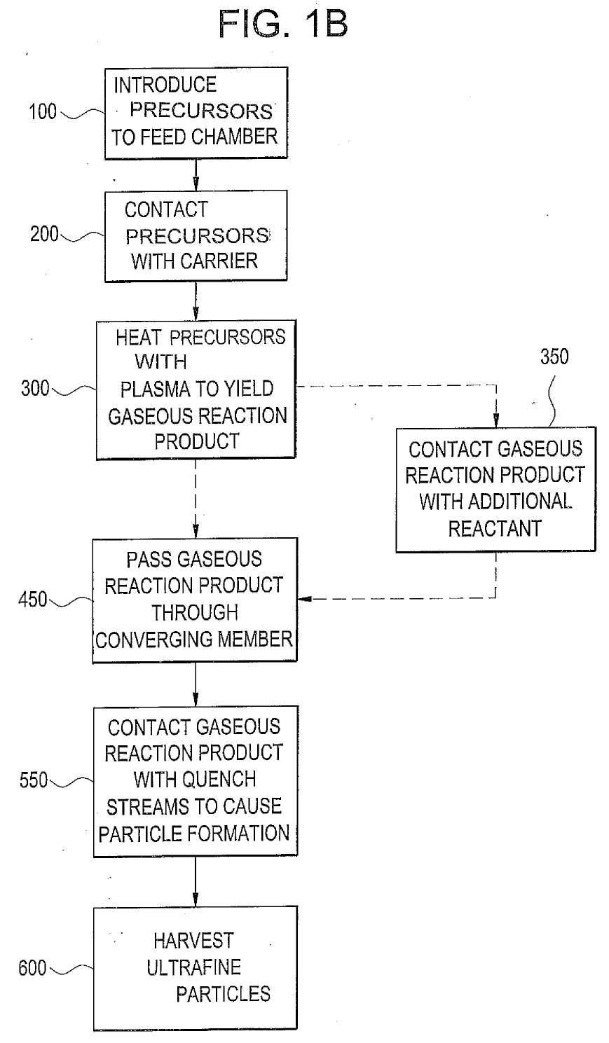

Referring now to FIGS. 1A and 1B, there are seen flow diagrams depicting certain methods for making the ultrafine corrosion resisting particles present in the coating compositions of the present invention. As is apparent, in certain embodiments the ultrafine corrosion resisting particles are made using a high temperature chamber, such as a plasma system, wherein, at step 100, one or more precursors are introduced into a feed chamber. As used herein, the term “precursor” refers to a substance from which a desired product is formed.

The precursor stream may be introduced to the plasma chamber as a solid, liquid, gas, or a mixture thereof. Suitable liquid precursors that may be used as part of the precursor stream include organometallics, such as, for example, manganese 2,4-pentanedionate, vanadium 2,4-pentanedionate, cobalt 2,4-pentanedionate, nickel 2,4-pentanedionate, copper 2,4-pentanedionate, titanium 2-ethylhexoide, iron 2-ethylhexanoate, and/or niobium ethoxide. Suitable solid precursors that may be used as part of the precursor stream include solid silica powder (such as silica fume, fumed silica, silica sand, and/or precipitated silica), as well as any of the unsaturated transition metal oxides described earlier.

Referring once again to FIGS. 1A and 1B it is seen that, at step 200, the precursor(s) are contacted with a carrier. The carrier may be a gas that acts to suspend the precursor(s) in the gas, thereby producing a gas-stream suspension of the precursors. Suitable carrier gases include, but are not limited to, argon, helium, nitrogen, oxygen, air, hydrogen, or a combination thereof.

Next, in accordance with certain methods for making ultrafine corrosion resisting particles, the precursor(s) are heated, at step 300, by means of a plasma as the precursor(s) flow through the plasma chamber, yielding a gaseous product stream. In certain embodiments, the precursor(s) are heated to a temperature ranging from 2,500° to 20,000° C., such as 1,700° to 8,000° C.

In certain embodiments, the gaseous product stream may be contacted with a reactant, such as a hydrogen-containing material, that may be injected into the plasma chamber, as indicated at step 350. The particular material used as the reactant is not limited, and may include, for example, air, water vapor, hydrogen gas, ammonia, and/or hydrocarbons, depending on the desired properties of the resulting ultrafine corrosion resisting particles.

As is apparent from FIG. 1A, in certain methods of the present invention, after the gaseous product stream is produced, it is, at step 400, contacted with a plurality of quench streams that are injected into the plasma chamber through a plurality of quench stream injection ports, wherein the quench streams are injected at flow rates and injection angles that result in impingement of the quench streams with each other within the gaseous product stream. The material used in the quench streams is not limited, so long as it adequately cools the gaseous product stream to cause formation of ultrafine particles. Thus, as used herein, the term “quench stream” refers to a stream that cools the gaseous product stream to such an extent so as to cause formation of ultrafine particles. Materials suitable for use in the quench streams include, but are not limited to, hydrogen gas, carbon dioxide, air, water vapor, ammonia, mono, di and polybasic alcohols, silicon-containing materials (such as hexamethyldisilazane), carboxylic acids, and/or hydrocarbons.

The particular flow rates and injection angles of the various quench streams may vary, so long as, in certain embodiments, they impinge with each other within the gaseous product stream to result in the rapid cooling of the gaseous product stream to produce ultrafine particles. This differentiates these methods for producing ultrafine particles from certain fast quench plasma systems that primarily or exclusively utilize Joule-Thompson adiabatic and isoentropic expansion through, for example, the use of a converging-diverging nozzle or a “virtual” converging-diverging nozzle, to form ultrafine particles. In these methods, the gaseous product stream is contacted with the quench streams to produce ultrafine particles before passing those particles through a converging member, such as, for example, a converging-diverging nozzle, which the inventors have surprisingly discovered aids in, inter alia, reducing the fouling or clogging of the plasma chamber, thereby enabling the production of ultrafine particles without frequent disruptions in the production process for cleaning of the plasma system. In these embodiments, the quench streams primarily cool the gaseous product stream through dilution, rather than adiabatic expansion, thereby causing a rapid quenching of the gaseous product stream and the formation of ultrafine particles prior to passing the particles into and through a converging member.

As used herein, the term “converging member” refers to a device that includes at least a section or portion that progresses from a larger diameter to a smaller diameter in the direction of flow, thereby restricting passage of a flow therethrough, which can permit control of the residence time of the flow in the plasma chamber due to a pressure differential upstream and downstream of the converging member. In certain embodiments, the converging member is a conical member, i.e., a member whose base is relatively circular and whose sides taper towards a point, whereas, in other embodiments, the converging member is a converging-diverging nozzle of the type described in U.S. Pat. No. RE 37,853 at col. 9, line 65 to col. 11, line 32, the cited portion of which being incorporated herein by reference.

Referring again to FIG. 1A, it is seen that, in certain embodiments, after contacting the gaseous product stream with the quench stream to cause production of ultrafine particles, the ultrafine particles are, at step 500, passed through a converging member, whereas, in other embodiments, as illustrated in FIG. 1B, the gaseous product stream is passed through a converging member at step 450 prior to contacting the stream with the quench streams to cause production of ultrafine particles at step 550. In either case, while the converging member may act to cool the product stream to some degree, the quench streams perform much of the cooling so that a substantial amount of ultrafine particles are formed upstream of the converging member in the embodiment illustrated by FIG. 1A or downstream of the converging member in the embodiment illustrated by FIG. 1B. Moreover, in either case, the converging member may primarily act as a choke position that permits operation of the reactor at higher pressures, thereby increasing the residence time of the materials therein. The combination of quench stream dilution cooling with a converging member appears to provide a commercially viable method of producing ultrafine particles using a plasma system, since, for example, (i) the precursor(s) can be used effectively without heating the feed material to a gaseous or liquid state before injection into the plasma, and (ii) fouling of the plasma system can be minimized, or eliminated, thereby reducing or eliminating disruptions in the production process for cleaning of the system.

As is seen in FIGS. 1A and 1B, in certain methods, after the ultrafine particles are produced, they are collected at step 600. Any suitable means may be used to separate the ultrafine particles from the gas flow, such as, for example, a bag filter or cyclone separator.

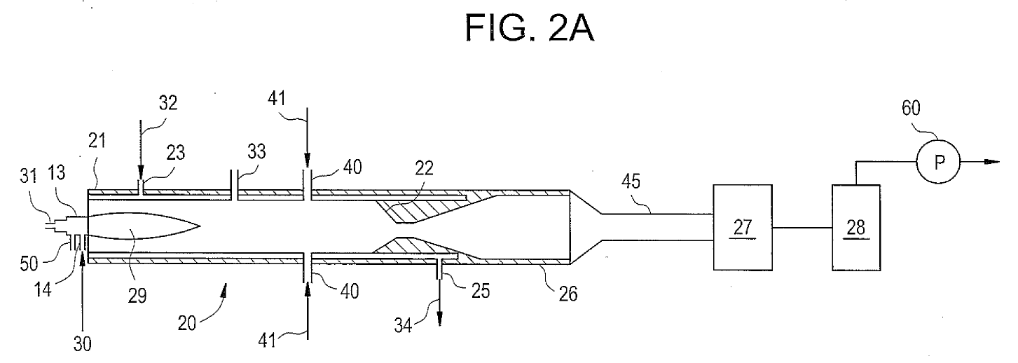

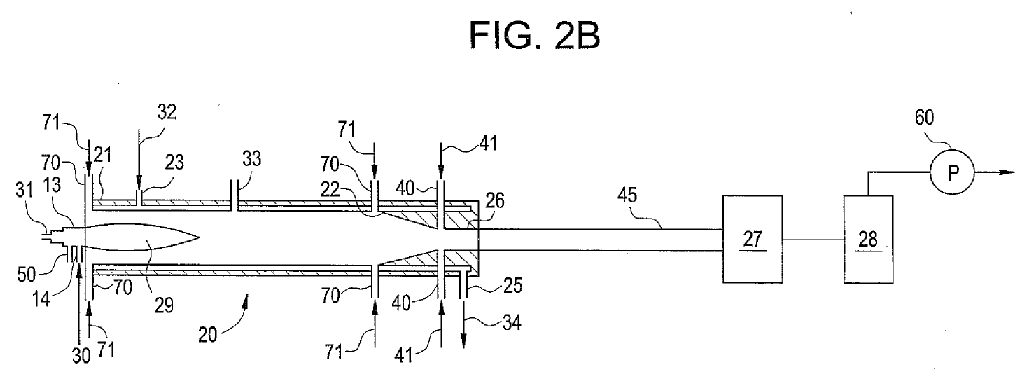

Now referring to FIGS. 2A and 2B, there are depicted schematic diagrams of an apparatus for producing ultrafine corrosion resisting particles that are included in the coating compositions of the present invention. As is apparent, in these embodiments, a plasma chamber 20 is provided that includes a precursor feed inlet 50. In certain embodiments, the precursor(s) are combined (not shown) prior to inlet 50. Also provided is at least one carrier gas feed inlet 14, through which a carrier gas flows in the direction of arrow 30 into the plasma chamber 20. As previously indicated, the carrier gas may act to suspend precursor(s) therein, thereby producing a gas-stream suspension of the precursor(s) which flows towards plasma 29. Numerals 23 and 25 designate cooling inlet and outlet respectively, which may be present for a double-walled plasma chamber 20. In these embodiments, coolant flow is indicated by arrows 32 and 34. Suitable coolants include both liquids and gasses depending upon the selected reactor geometry and materials of construction.

In the embodiments depicted by FIGS. 2A and 2B, a plasma torch 21 is provided. Torch 21 thermally decomposes the incoming gas-stream suspension of precursor(s) within the resulting plasma 29 as the stream is delivered through the inlet of the plasma chamber 20, thereby producing a gaseous product stream. As is seen in FIGS. 2A and 2B, the precursors are, in certain embodiments, injected downstream of the location where the arc attaches to the annular anode 13 of the plasma generator or torch.

A plasma is a high temperature luminous gas which is at least partially (1 to 100%) ionized. A plasma is made up of gas atoms, gas ions, and electrons. A thermal plasma can be created by passing a gas through an electric arc. The electric arc will rapidly heat the gas by resistive and radiative heating to very high temperatures within microseconds of passing through the arc. The plasma is often luminous at temperatures above 9000 K.

A plasma can be produced with any of a variety of gases. This can give excellent control over any chemical reactions taking place in the plasma as the gas may be inert, such as argon, helium, or neon, reductive, such as hydrogen, methane, ammonia, and carbon monoxide, or oxidative, such as oxygen, nitrogen, and carbon dioxide. Air, oxygen, and/or oxygen/argon gas mixtures are often used to produce ultrafine corrosion resisting particles in accordance with the present invention. In FIGS. 2A and 2B, the plasma gas feed inlet is depicted at 31.

As the gaseous product stream exits the plasma 29 it proceeds towards the outlet of the plasma chamber 20. As is apparent, a reactant, as described earlier, can be injected into the reaction chamber prior to the injection of the quench streams. A supply inlet for the reactant is shown in FIGS. 2A and 2B at 33.

As is seen in FIGS. 2A and 2B, in certain embodiments, the gaseous product stream is contacted with a plurality of quench streams which enter the plasma chamber 20 in the direction of arrows 41 through a plurality of quench stream injection ports 40 located along the circumference of the plasma chamber 20. As previously indicated, the particular flow rate and injection angle of the quench streams is not limited so long as, in certain embodiments, they result in impingement of the quench streams 41 with each other within the gaseous product stream, in some cases at or near the center of the gaseous product stream, to result in the rapid cooling of the gaseous product stream to produce ultrafine particles. This results in a quenching of the gaseous product stream through dilution to form ultrafine particles.

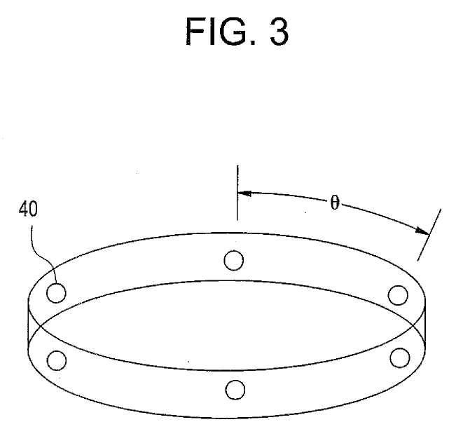

Referring now to FIG. 3, there is depicted a perspective view of a plurality of quench stream injection ports 40. In this particular embodiment, six (6) quench stream injection ports are depicted, wherein each port is disposed at an angle “θ” apart from each other along the circumference of the reactor chamber 20. It will be appreciated that “θ” may have the same or a different value from port to port. In certain embodiments, at least four (4) quench stream injection ports 40 are provided, in some cases at least six (6) quench stream injection ports are present or, in other embodiments, twelve (12) or more quench stream injection ports are present. In certain embodiments, each angle “θ” has a value of no more than 90°. In certain embodiments, the quench streams are injected into the plasma chamber normal (90° angle) to the flow of the gaseous reaction product. In some cases, however, positive or negative deviations from the 90° angle by as much as 30° may be used.

In certain embodiments, such as is depicted in FIG. 2B, one or more sheath streams are injected into the plasma chamber upstream of the converging member. As used herein, the term “sheath stream” refers to a stream of gas that is injected prior to the converging member and which is injected at flow rate(s) and injection angle(s) that result in a barrier separating the gaseous product stream from the plasma chamber walls, including the converging portion of the converging member. The material used in the sheath stream(s) is not limited, so long as the stream(s) act as a barrier between the gaseous product stream and the converging portion of the converging member, as illustrated by the prevention, to at least a significant degree, of material sticking to the interior surface of the plasma chamber walls, including the converging member. For example, materials suitable for use in the sheath stream(s) include, but are not limited to, those materials described earlier with respect to the quench streams. A supply inlet for the sheath stream is shown in FIG. 2B at 70 and the direction of flow is indicated by numeral 71.

By proper selection of converging member dimensions, the plasma chamber 20 can be operated at atmospheric pressure, or slightly less than atmospheric pressure, or, in some cases, at a pressurized condition, to achieve the desired residence time, while the chamber 26 downstream of the converging member 22 is maintained at a vacuum pressure by operation of a vacuum producing device, such as a vacuum pump 60. Following production of the ultrafine particles, they may then enter a cool down chamber 26.

As is apparent from FIGS. 2A and 2B, in certain embodiments, the ultrafine corrosion resisting particles may flow from cool down chamber 26 to a collection station 27 via a cooling section 45, which may comprise, for example, a jacketed cooling tube. In certain embodiments, the collection station 27 comprises a bag filter or other collection means. A downstream scrubber 28 may be used if desired to condense and collect material within the flow prior to the flow entering vacuum pump 60.

In certain embodiments, the precursors are injected under pressure (such as greater than 1 to 100 atmospheres) through a small orifice to achieve sufficient velocity to penetrate and mix with the plasma. In addition, in many cases the injected stream of precursors is injected normal (90° angle) to the flow of the plasma gases. In some cases, positive or negative deviations from the 90° angle by as much as 30° may be desired.

The high temperature of the plasma rapidly vaporizes the precursor(s). There can be a substantial difference in temperature gradients and gaseous flow patterns along the length of the plasma chamber 20. It is believed that, at the plasma arc inlet, flow is turbulent and there is a high temperature gradient; from temperatures of about 20,000 K at the axis of the chamber to about 375 K at the chamber walls.

The plasma chamber is often constructed of water cooled stainless steel, nickel, titanium, copper, aluminum, or other suitable materials. The plasma chamber can also be constructed of ceramic materials to withstand a vigorous chemical and thermal environment.

The plasma chamber walls may be internally heated by a combination of radiation, convection and conduction. In certain embodiments, cooling of the plasma chamber walls prevents unwanted melting and/or corrosion at their surfaces. The system used to control such cooling should maintain the walls at as high a temperature as can be permitted by the selected wall material, which often is inert to the materials within the plasma chamber at the expected wall temperatures. This is true also with regard to the nozzle walls, which may be subjected to heat by convection and conduction.

The length of the plasma chamber is often determined experimentally by first using an elongated tube within which the user can locate the target threshold temperature. The plasma chamber can then be designed long enough so that the materials have sufficient residence time at the high temperature to reach an equilibrium state and complete the formation of the desired end products.

The inside diameter of the plasma chamber 20 may be determined by the fluid properties of the plasma and moving gaseous stream. It should be sufficiently great to permit necessary gaseous flow, but not so large that recirculating eddies or stagnant zones are formed along the walls of the chamber. Such detrimental flow patterns can cool the gases prematurely and precipitate unwanted products. In many cases, the inside diameter of the plasma chamber 20 is more than 100% of the plasma diameter at the inlet end of the plasma chamber.

In certain embodiments of the present invention, the previously described corrosion resisting particles comprising an unsaturated transition metal oxide are present in the coating compositions of the present invention in an amount of 3 to 50 percent by volume, such as 8 to 30 percent by volume, or, in certain embodiments, 10 to 18 percent by volume, wherein the volume percents are based on the total volume of the coating composition.

As previously indicated, in certain embodiments, the coating compositions of the present invention comprise a film-forming resin. As used herein, the term “film-forming resin” refers to resins that can form a self-supporting continuous film on at least a horizontal surface of a substrate upon removal of any diluents or carriers present in the composition or upon curing at ambient or elevated temperature.

Film-forming resins that may be used in the coating compositions of the present invention include, without limitation, those used in automotive OEM coating compositions, automotive refinish coating compositions, industrial coating compositions, architectural coating compositions, coil coating compositions, and aerospace coating compositions, among others.

In certain embodiments, the film-forming resin included within the coating compositions of the present invention comprises a thermosetting film-forming resin. As used herein, the term “thermosetting” refers to resins that “set” irreversibly upon curing or crosslinking, wherein the polymer chains of the polymeric components are joined together by covalent bonds. This property is usually associated with a cross-linking reaction of the composition constituents often induced, for example, by heat or radiation. See Hawley, Gessner G., The Condensed Chemical Dictionary, Ninth Edition., page 856; Surface Coatings, vol. 2, Oil and Colour Chemists' Association, Australia, TAFE Educational Books (1974). Curing or crosslinking reactions also may be carried out under ambient conditions. Once cured or crosslinked, a thermosetting resin will not melt upon the application of heat and is insoluble in solvents. In other embodiments, the film-forming resin included within the coating compositions of the present invention comprises a thermoplastic resin. As used herein, the term “thermoplastic” refers to resins that comprise polymeric components that are not joined by covalent bonds and thereby can undergo liquid flow upon heating and are soluble in solvents. See Saunders, K. J., Organic Polymer Chemistry, pp. 41-42, Chapman and Hall, London (1973).

Film-forming resins suitable for use in the coating compositions of the present invention include, for example, those formed from the reaction of a polymer having at least one type of reactive group and a curing agent having reactive groups reactive with the reactive group(s) of the polymer. As used herein, the term “polymer” is meant to encompass oligomers, and includes, without limitation, both homopolymers and copolymers. The polymers can be, for example, acrylic, saturated or unsaturated polyester, polyurethane or polyether, polyvinyl, cellulosic, acrylate, silicon-based polymers, co-polymers thereof, and mixtures thereof, and can contain reactive groups such as epoxy, carboxylic acid, hydroxyl, isocyanate, amide, carbamate and carboxylate groups, among others, including mixtures thereof.

Suitable acrylic polymers include, for example, those described in United States Patent Application Publication 2003/0158316 A1 at [0030]-[0039], the cited portion of which being incorporated herein by reference. Suitable polyester polymers include, for example, those described in United States Patent Application Publication 2003/0158316 A1 at [0040]-[0046], the cited portion of which being incorporated herein by reference. Suitable polyurethane polymers include, for example, those described in United States Patent Application Publication 2003/0158316 A1 at [0047]-[0052], the cited portion of which being incorporated herein by reference. Suitable silicon-based polymers are defined in U.S. Pat. No. 6,623,791 at col. 9, lines 5-10, the cited portion of which being incorporated herein by reference.

In certain embodiments of the present invention, the film-forming resin comprises a polyvinyl polymer, such as a polyvinyl butyral resin. Such resins may be produced by reacting a polyvinyl alcohol with an aldehyde, such as acetaldehyde, formaldehyde, or butyraldehyde, among others. Polyvinyl alcohols may be produced by the polymerization of vinyl acetate monomer and the subsequent, alkaline-catalyzed methanolysis of the polyvinyl acetate obtained. The acetalization reaction of polyvinyl alcohol and butyraldehyde is not quantitative, so the resulting polyvinyl butyral may contain a certain amount of hydroxyl groups. In addition, a small amount of acetyl groups may remain in the polymer chain.

Commercially available polyvinyl butyral resins may be used. Such resins often have an average degree of polymerization of 500 to 1000 and a degree of butyration of 57 to 70 mole percent. Specific examples of suitable polyvinyl butyral resins include the MOWITAL® line of polyvinyl butyral resins commercially available from Kuraray America, Inc., New York, N.Y.

As indicated earlier, certain coating compositions of the present invention can include a film-forming resin that is formed from the use of a curing agent. As used herein, the term “curing agent” refers to a material that promotes “cure” of composition components. As used herein, the term “cure” means that any crosslinkable components of the composition are at least partially crosslinked. In certain embodiments, the crosslink density of the crosslinkable components, i.e., the degree of crosslinking, ranges from 5 percent to 100 percent of complete crosslinking, such as 35 percent to 85 percent of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer, as is described in U.S. Pat. No. 6,803,408, at col. 7, line 66 to col. 8, line 18, the cited portion of which being incorporated herein by reference.

Any of a variety of curing agents known to those skilled in the art may be used. For example exemplary suitable aminoplast and phenoplast resins are described in U.S. Pat. No. 3,919,351 at col. 5, line 22 to col. 6, line 25, the cited portion of which being incorporated herein by reference. Exemplary suitable polyisocyanates and blocked isocyanates are described in U.S. Pat. No. 4,546,045 at col. 5, lines 16 to 38; and in U.S. Pat. No. 5,468,802 at col. 3, lines 48 to 60, the cited portions of which being incorporated herein by reference. Exemplary suitable anhydrides are described in U.S. Pat. No. 4,798,746 at col. 10, lines 16 to 50; and in U.S. Pat. No. 4,732,790 at col. 3, lines 41 to 57, the cited portions of which being incorporated herein by reference. Exemplary suitable polyepoxides are described in U.S. Pat. No. 4,681,811 at col. 5, lines 33 to 58, the cited portion of which being incorporated herein by reference. Exemplary suitable polyacids are described in U.S. Pat. No. 4,681,811 at col. 6, line 45 to col. 9, line 54, the cited portion of which being incorporated herein by reference. Exemplary suitable polyols are described in U.S. Pat. No. 4,046,729 at col. 7, line 52 to col. 8, line 9 and col. 8, line 29 to col. 9, line 66, and in U.S. Pat. No. 3,919,315 at col. 2, line 64 to col. 3, line 33, the cited portions of which being incorporated herein by reference. Examples suitable polyamines described in U.S. Pat. No. 4,046,729 at col. 6, line 61 to col. 7, line 26, and in U.S. Pat. No. 3,799,854 at column 3, lines 13 to 50, the cited portions of which being incorporated herein by reference. Appropriate mixtures of curing agents, such as those described above, may be used.

In certain embodiments, the coating compositions of the present invention are formulated as a one-component composition where a curing agent is admixed with other composition components to form a storage stable composition. In other embodiments, compositions of the present invention can be formulated as a two-component composition where a curing agent is added to a pre-formed admixture of the other composition components just prior to application.

In certain embodiments, the film-forming resin is present in the coating compositions of the present invention in an amount greater than 30 weight percent, such as 40 to 90 weight percent, or, in some cases, 50 to 90 weight percent, with weight percent being based on the total weight of the coating composition. When a curing agent is used, it may, in certain embodiments, be present in an amount of up to 70 weight percent, such as 10 to 70 weight percent; this weight percent is also based on the total weight of the coating composition.

In certain embodiments, the coating compositions of the present invention are in the form of liquid coating compositions, examples of which include aqueous and solvent-based coating compositions and electrodepositable coating compositions. The coating compositions of the present invention may also be in the form of a co-reactable solid in particulate form, i.e., a powder coating composition. Regardless of the form, the coating compositions of the present invention may be pigmented or clear, and may be used alone or in combination as primers, basecoats, or topcoats. Certain embodiments of the present invention, as discussion in more detail below, are directed to corrosion resistant primer and/or pretreatment coating compositions. As indicated, certain embodiments of the present invention are directed to metal substrate primer coating compositions, such as “etch primers,” and/or metal substrate pretreatment coating compositions. As used herein, the term “primer coating composition” refers to coating compositions from which an undercoating may be deposited onto a substrate in order to prepare the surface for application of a protective or decorative coating system. As used herein, the term “etch primer” refers to primer coating compositions that include an adhesion promoting component, such as a free acid as described in more detail below. As used herein, the term “pretreatment coating composition” refers to coating compositions that can be applied at very low film thickness to a bare substrate to improve corrosion resistance or to increase adhesion of subsequently applied coating layers. Metal substrates that may be coated with such compositions include, for example, substrates comprising steel (including electrogalvanized steel, cold rolled steel, hot-dipped galvanized steel, among others), aluminum, aluminum alloys, zinc-aluminum alloys, and aluminum plated steel. Substrates that may be coated with such compositions also may comprise more than one metal or metal alloy, in that the substrate may be a combination of two or more metal substrates assembled together, such as hot-dipped galvanized steel assembled with aluminum substrates.

The metal substrate primer coating compositions and/or metal substrate pretreatment coating compositions of the present invention may be applied to bare metal. By “bare” is meant a virgin material that has not been treated with any pretreatment compositions, such as, for example, conventional phosphating baths, heavy metal rinses, etc. Additionally, bare metal substrates being coated with the primer coating compositions and/or pretreatment coating compositions of the present invention may be a cut edge of a substrate that is otherwise treated and/or coated over the rest of its surface.

Before applying a coating composition of the present invention, the metal substrate to be coated may first be cleaned to remove grease, dirt, or other extraneous matter. Conventional cleaning procedures and materials may be employed. These materials could include, for example, mild or strong alkaline cleaners, such as those that are commercially available. Examples include BASE Phase Non-Phos or BASE Phase #6, both of which are available from PPG Industries, Pretreatment and Specialty Products. The application of such cleaners may be followed and/or preceded by a water rinse.

The metal surface may then be rinsed with an aqueous acidic solution after cleaning with the alkaline cleaner and before contact with a metal substrate primer coating composition and/or metal substrate pretreatment composition of the present invention. Examples of suitable rinse solutions include mild or strong acidic cleaners, such as the dilute nitric acid solutions commercially available.

As previously indicated, certain embodiments of the present invention are directed to coating compositions comprising an adhesion promoting component. As used herein, the term “adhesion promoting component” refers to any material that is included in the composition to enhance the adhesion of the coating composition to a metal substrate.

In certain embodiments of the present invention, such an adhesion promoting component comprises a free acid. As used herein, the term “free acid” is meant to encompass organic and/or inorganic acids that are included as a separate component of the compositions of the present invention as opposed to any acids that may be used to form a polymer that may be present in the composition. In certain embodiments, the free acid included within the coating compositions of the present invention is selected from tannic acid, gallic acid, phosphoric acid, phosphorous acid, citric acid, malonic acid, a derivative thereof, or a mixture thereof. Suitable derivatives include esters, amides, and/or metal complexes of such acids.

In certain embodiments, the free acid comprises an organic acid, such as tannic acid, i.e., tannin. Tannins are extracted from various plants and trees which can be classified according to their chemical properties as (a) hydrolyzable tannins, (b) condensed tannins, and (c) mixed tannins containing both hydrolyzable and condensed tannins. Tannins useful in the present invention include those that contain a tannin extract from naturally occurring plants and trees, and are normally referred to as vegetable tannins. Suitable vegetable tannins include the crude, ordinary or hot-water-soluble condensed vegetable tannins, such as Quebracho, mimosa, mangrove, spruce, hemlock, gabien, wattles, catechu, uranday, tea, larch, myrobalan, chestnut wood, divi-divi, valonia, summac, chinchona, oak, etc. These vegetable tannins are not pure chemical compounds with known structures, but rather contain numerous components including phenolic moieties such as catechol, pyrogallol, etc., condensed into a complicated polymeric structure.

In certain embodiments, the free acid comprises a phosphoric acid, such as a 100 percent orthophosphoric acid, superphosphoric acid or the aqueous solutions thereof, such as a 70 to 90 percent phosphoric acid solution.

In addition to or in lieu of such free acids, other suitable adhesion promoting components are metal phosphates, organophosphates, and organophosphonates. Suitable organophosphates and organophosphonates include those disclosed in U.S. Pat. No. 6,440,580 at col. 3, line 24 to col. 6, line 22, U.S. Pat. No. 5,294,265 at col. 1, line 53 to col. 2, line 55, and U.S. Pat. No. 5,306,526 at col. 2, line 15 to col. 3, line 8, the cited portions of which being incorporated herein by reference. Suitable metal phosphates include, for example, zinc phosphate, iron phosphate, manganese phosphate, calcium phosphate, magnesium phosphate, cobalt phosphate, zinc-iron phosphate, zinc-manganese phosphate, zinc-calcium phosphate, including the materials described in U.S. Pat. Nos. 4,941,930, 5,238,506, and 5,653,790.

In certain embodiments, the adhesion promoting component comprises a phosphatized epoxy resin. Such resins may comprise the reaction product of one or more epoxy-functional materials and one or more phosphorus-containing materials. Non-limiting examples of such materials, which are suitable for use in the present invention, are disclosed in U.S. Pat. No. 6,159,549 at col. 3, lines 19 to 62, the cited portion of which being incorporated by reference herein.

In certain embodiments, the adhesion promoting component is present in the coating composition in an amount ranging from 0.05 to 20 percent by weight, such as 3 to 15 percent by weight, with the percents by weight being based on the total weight of the composition.

In certain embodiments, the coating compositions of the present invention may also comprise additional optional ingredients, such as those ingredients well known in the art of formulating surface coatings. Such optional ingredients may comprise, for example, surface active agents, flow control agents, thixotropic agents, fillers, anti-gassing agents, organic co-solvents, catalysts, antioxidants, light stabilizers, UV absorbers and other customary auxiliaries. Any such additives known in the art can be used, absent compatibility problems. Non-limiting examples of these materials and suitable amounts include those described in U.S. Pat. Nos. 4,220,679; 4,403,003; 4,147,769; and 5,071,904.

In certain embodiments, the coating compositions of the present invention comprise one or more colorants. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which are incorporated herein by reference.

Example special effect compositions that may be used in the coating compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

In certain embodiments, the coating compositions of the present invention also comprise, in addition to any of the previously described corrosion resisting particles, conventional non-chrome corrosion resisting particles. Suitable conventional non-chrome corrosion resisting particles include, but are not limited to, iron phosphate, zinc phosphate, calcium ion-exchanged silica, colloidal silica, synthetic amorphous silica, and molybdates, such as calcium molybdate, zinc molybdate, barium molybdate, strontium molybdate, and mixtures thereof. Suitable calcium ion-exchanged silica is commercially available from W. R. Grace & Co. as SHIELDEX® AC3 and/or SHIELDEX® C303. Suitable amorphous silica is available from W. R. Grace & Co. under the tradename SYLOID®. Suitable zinc hydroxyl phosphate is commercially available from Elementis Specialties, Inc. under the tradename NALZIN® 2.

These conventional non-chrome corrosion resisting pigments typically comprise particles having a particle size of approximately one micron or larger. In certain embodiments, these particles are present in the coating compositions of the present invention in an amount ranging from 5 to 40 percent by weight, such as 10 to 25 percent by weight, with the percents by weight being based on the total solids weight of the composition.

In certain embodiments, the present invention is directed to coating compositions comprising an adhesion promoting component, a phenolic resin and an alkoxysilane, in addition to the previously described corrosion resisting particles comprising an unsaturated transition metal oxide. Suitable phenolic resins include those resins prepared by the condensation of a phenol or an alkyl substituted phenol with an aldehyde. Exemplary phenolic resins include those described in U.S. Pat. No. 6,774,168 at col. 2, lines 2 to 22, the cited portions of which being incorporated herein by reference. Suitable alkoxysilanes are described in U.S. Pat. No. 6,774,168 at col. 2, lines 23 to 65 and include, for example, acryloxyalkoxysilanes, such as 7-acryloxypropyltrimethoxysilane and methacrylatoalkoxysilane, such as 7-methacryloxypropyltrimethoxysilane. Such compositions may also include a solvent, Theological agent, and/or pigment, as described in U.S. Pat. No. 6,774,168 at col. 3, lines 28 to 41, the cited portion of which being incorporated by reference herein.

The coating compositions of the present invention may be prepared by any of a variety of methods. For example, in certain embodiments, the previously described corrosion resisting particles comprising an unsaturated transition metal oxide are added at any time during the formulation of a coating composition comprising a film-forming resin, so long as they form a stable suspension in a film-forming resin. Coating compositions of the present invention can be prepared by first blending a film-forming resin, the previously described corrosion resisting particles, and a diluent, such as an organic solvent and/or water, in a closed container that contains ceramic grind media. The blend is subjected to high shear stress conditions, such as by shaking the blend on a high speed shaker, until a homogeneous dispersion of particles remains suspended in the film-forming resin with no visible particle settle in the container. If desired, any mode of applying stress to the blend can be utilized, so long as sufficient stress is applied to achieve a stable dispersion of the particles in the film-forming resin.

The coating compositions of the present invention may be applied to a substrate by known application techniques, such as dipping or immersion, spraying, intermittent spraying, dipping followed by spraying, spraying followed by dipping, brushing, or by roll-coating. Usual spray techniques and equipment for air spraying and electrostatic spraying, either manual or automatic methods, can be used. While the coating compositions of the present invention can be applied to various substrates, such as wood, glass, cloth, plastic, foam, including elastomeric substrates and the like, in many cases, the substrate comprises a metal.

In certain embodiments of the coating compositions of the present invention, after application of the composition to the substrate, a film is formed on the surface of the substrate by driving solvent, i.e., organic solvent and/or water, out of the film by heating or by an air-drying period. Suitable drying conditions will depend on the particular composition and/or application, but in some instances a drying time of from about 1 to 5 minutes at a temperature of about 80 to 250° F. (20 to 121° C.) will be sufficient. More than one coating layer may be applied if desired. Usually between coats, the previously applied coat is flashed; that is, exposed to ambient conditions for 5 to 30 minutes. In certain embodiments, the thickness of the coating is from 0.05 to 5 mils (1.3 to 127 microns), such as 0.05 to 3.0 mils (1.3 to 76.2 microns). The coating composition may then be heated. In the curing operation, solvents are driven off and crosslinkable components of the composition, if any, are crosslinked. The heating and curing operation is sometimes carried out at a temperature in the range of from 160 to 350° F. (71 to 177° C.) but, if needed, lower or higher temperatures may be used.

As indicated, certain embodiments of the coating compositions of the present invention are directed to primer compositions, such as “etch primers,” while other embodiments of the present invention are directed to metal substrate pretreatment compositions. In either case, such compositions are often topcoated with a protective and decorative coating system, such as a monocoat topcoat or a combination of a pigmented base coating composition and a clearcoat composition, i.e., a color-plus-clear system. As a result, the present invention is also directed to multi-component composite coatings comprising at least one coating layer deposited from a coating composition of the present invention. In certain embodiments, the multi-component composite coating compositions of the present invention comprise a base-coat film-forming composition serving as a basecoat (often a pigmented color coat) and a film-forming composition applied over the basecoat serving as a topcoat (often a transparent or clear coat).

In these embodiments of the present invention, the coating composition from which the basecoat and/or topcoat is deposited may comprise, for example, any of the conventional basecoat or topcoat coating compositions known to those skilled in the art of, for example, formulating automotive OEM coating compositions, automotive refinish coating compositions, industrial coating compositions, architectural coating compositions, coil coating compositions, and aerospace coating compositions, among others. Such compositions typically include a film-forming resin that may include, for example, an acrylic polymer, a polyester, and/or a polyurethane. Exemplary film-forming resins are disclosed in U.S. Pat. No. 4,220,679, at col. 2 line 24 to col. 4, line 40; as well as U.S. Pat. No. 4,403,003, U.S. Pat. No. 4,147,679 and U.S. Pat. No. 5,071,904.

The present invention is also directed to substrates, such as metal substrates, at least partially coated with a coating composition of the present invention as well as substrates, such as metal substrates, at least partially coated with a multi-component composite coating of the present invention.

Illustrating the invention are the following examples, which, however, are not to be considered as limiting the invention to their details. Unless otherwise indicated, all parts and percentages in the following examples, as well as throughout the specification, are by weight.

### EXAMPLES

The following Particle Examples describe the preparation of corrosion resisting particles suitable for use in certain embodiments of the coating compositions of the present invention.

### Particle Example 1

Particles were prepared using a DC thermal plasma system. The plasma system included a DC plasma torch (Model SG-100 Plasma Spray Gun commercially available from Praxair Technology, Inc., Danbury, Conn.) operated with 60 standard liters per minute of argon carrier gas and 26 kilowatts of power delivered to the torch. A solid precursor feed composition comprising the materials and amounts listed in Table 1 was prepared and fed to the reactor at a rate of 1.1 grams per minute through a gas assistant powder feeder (Model 1264 commercially available from Praxair Technology) located at the plasma torch outlet. At the powder feeder, 5.2 standard liters per minute argon was delivered as a carrier gas. Oxygen was delivered at 10 standard liters per minute through two ⅛″ diameter nozzles located 180° apart at 0.69″ downstream of the powder injection port. Following a 9.7 inch long reactor section, a plurality of quench stream injection ports were provided that included 6⅛ inch diameter nozzles located 60° apart radially. A 7 millimeter diameter converging-diverging nozzle of the type described in U.S. Pat. No. RE 37,853E was located 3 inches downstream of the quench stream injection ports. Quench air was injected through the plurality of at the quench stream injection ports at a rate of 100 standard liters per minute.

TABLE 1

| Material | Amount |
|---|---|
| Mn(IV)O₂¹ | 10 grams |
| Silica² | 90 grams |

¹Commercially available from Sigma Aldrich Co., St Louis, Missouri.
²Commercially available under the tradename WB-10 from PPG Industries, Inc., Pittsburgh, PA.

The produced particles had a theoretical composition of 10 weight percent manganese (IV) oxide and 90 weight percent silica. The measured B.E.T. specific surface area was 331 square meters per gram using the Gemini model 2360 analyzer and the calculated equivalent spherical diameter was 7 nanometers.

### Particle Example 2

Particles from solid precursors were prepared using the apparatus and conditions identified in Example 1, except the feed materials and amounts are listed in Table 2.

TABLE 2

| Material | Amount |
|---|---|
| Mn(IV)O₂¹ | 20 grams |
| Silica² | 80 grams |

The produced particles had a theoretical composition of 20 weight percent manganese (IV) oxide and 80 weight percent silica. The measured B.E.T. specific surface area was 214 square meters per gram using the Gemini model 2360 analyzer and the calculated equivalent spherical diameter was 10 nanometers.

### Particle Example 3

Particles from solid precursors were prepared using the apparatus and conditions identified in Example 1, except the feed materials and amounts are listed in Table 3.

TABLE 3

| Material | Amount |
|---|---|
| Mn(II)O³ | 10 grams |
| Silica² | 90 grams |

³Commercially available from Sigma Aldrich Co., St Louis, Missouri.

The produced particles had a theoretical composition of 10 weight percent manganese (II) oxide and 90 weight percent silica. The measured B.E.T. specific surface area was 208 square meters per gram using the Gemini model 2360 analyzer and the calculated equivalent spherical diameter was 11 nanometers.

### Particle Example 4

Particles from solid precursors were prepared using the precursors, apparatus and conditions identified in Example 3, except that argon was used as quench gas and was injected at the quench gas injection ports at a rate of 145 standard liters per minute.

The produced particles had a theoretical composition of 10 weight percent manganese (II) oxide and 90 weight percent silica. The measured B.E.T. specific surface area was 226 square meters per gram using the Gemini model 2360 analyzer and the calculated equivalent spherical diameter was 11 nanometers.

### Coating Composition Examples 1-6

Coating compositions were prepared using the components and weights (in grams) shown in Table 4. All materials in the A side of the formulation, were added under agitation with a Cowles blade in the order listed. Poly(vinyl butyral) resin was slowly added under agitation and left to mix for 15 minutes before adding the next materials. The final mixture was allowed to mix for ten minutes and was then added to a sealed 8 ounce glass container containing approximately 150 grams of the above material to approximately 125 grams of zircoa beads. This sealed container was then left on a paint shaker for two to 4 hours. After removing the paste from the paint shaker the milling beads were filtered out with a standard paint filter and the finished material is ready.

The B side of the formulation is the DPX172, commercially available from PPG industries, Inc.

When ready to spray the above formulation A and B packs are mixed in the desired proportions and the compositions was ready to be applied.

TABLE 4

| Pack | Material | Ex. 1 | Ex. 2 | Ex. 3 | Ex. 4 | Ex. 5 | Ex. 6 |
|---|---|---|---|---|---|---|---|
| A | Isopropanol¹ | 8.8 | 8.8 | 8.8 | 8.8 | 8.8 | 8.8 |
| A | NORMAL BUTYL | 18.31 | 18.31 | 18.31 | 18.31 | 18.31 | 18.31 |
| | ALCOHOL² | | | | | | |
| A | Toluene³ | 21.37 | 21.37 | 21.37 | 21.37 | 21.37 | 21.37 |
| A | MPA 2000T/#202-T | 0.87 | 0.87 | 0.87 | 0.87 | 0.87 | 0.87 |
| | ANTI-SETTLING | | | | | | |
| | AGT⁴ | | | | | | |
| A | Ethanol⁵ | 29.51 | 29.51 | 29.51 | 29.51 | 29.51 | 29.51 |
| A | ANTI-TERRA-U⁶ | 0.35 | 0.35 | 0.35 | 0.35 | 0.35 | 0.35 |
| A | PHENODUR PR 263⁷ | 2.34 | 2.34 | 2.34 | 2.34 | 2.34 | 2.34 |
| A | MOWITAL B30H⁸ | 6.22 | 6.22 | 6.22 | 6.22 | 6.22 | 6.22 |
| A | RAVEN 410⁹ | 0.12 | 0.12 | 0.12 | 0.12 | 0.12 | 0.12 |
| A | Aerosil 200¹⁰ | 0.12 | 0.12 | 0.12 | 0.12 | 0.12 | 0.12 |
| A | MICROTALC- | 7.57 | 7.57 | 7.57 | 7.57 | 7.57 | 7.57 |
| | MONTANA | | | | | | |
| | TALC MP 15-38¹¹ | | | | | | |
| A | NALZIN-2¹² | 8.02 | — | — | — | — | — |
| A | Example 4 Particles | — | 8.02 | — | — | — | — |
| A | Example 1 Particles | — | — | 8.02 | — | — | — |
| A | Example 2 Particles | — | — | — | 8.02 | — | — |
| A | Example 3 Particles | — | — | — | — | 8.02 | — |
| A | MAPICO YELLOW | 1.48 | 1.48 | 1.48 | 1.48 | 1.48 | 1.48 |
| | 2150A¹³ | | | | | | |
| A | TRONOX CR-800¹⁴ | 4.9 | 4.9 | 4.9 | 4.9 | 4.9 | 4.9 |
| A | EPON 834-X-80¹⁵ | 1.59 | 1.59 | 1.59 | 1.59 | 1.59 | 1.59 |
| A | NUXTRA ZINC | 0.75 | 0.75 | 0.75 | 0.75 | 0.75 | 0.75 |
| | 16%¹⁶ | | | | | | |
| B | DPX 172¹⁷ | 77.45 | 77.45 | 77.45 | 77.45 | 77.45 | 77.45 |

¹Organic solvent commercially available from British Petroleum.
²Organic solvent commercially available from BASF Corporation.
³Organic solvent commercially available from Ashland Chemical Co.
⁴Rheological additive commercially available from Elementis Specialties, Inc.
⁵Organic solvent commercially available from ChemCentral Corp.
⁶Wetting additive commercially available from BYK-Chemie GmbH.
⁷Phenolic resin commercially available from UCB Chemical, Inc.
⁸Polyvinyl butyral resin commercially available from Kuraray Co., Ltd.
⁹Carbon black powder commercially available from Columbian Chemicals Co.
¹⁰Silicon dioxide commercially available from Cabot Corp.
¹¹Talc commercially available from Barretts Minerals, Inc.
¹²Zinc hydroxyl phosphate anti-corrosion pigment commercially available from Elementis Specialties, Inc.
¹³Iron oxide pigment commercially available from Rockwood Pigments NA, Inc.
¹⁴Titanium dioxide pigment commercially available from Kerr-McGee Corp.
¹⁵Epichlorohydrin-Bisphenol A resin commercially available from Resolution Performance Products.
¹⁶Zinc 2-ethyl hexanoate solution commercially available from Condea Servo LLC.
¹⁷Catalyst commercially available from PPG Industries, Inc.

### Test Substrates

The compositions of Table 4, as well as Examples 7 and 8 (described below), were applied to the test substrates identified in Table 5. The substrates were prepared by first cleaning with a wax and greater remover (DX330, commercially available from PPG Industries, Inc.) and allowed to dry. The panels were then sanded with 180 grit using a DA orbital sander and again cleaned with DX330. The compositions were applied using a DeVilbiss GTI HVLP spray gun with a 1.4 spray tip, N2000 Cap, and 30 psi at gun. Each composition was applied in two coats with a five-minute flash in between to film builds of 0.50 to approximately 1.25 mils (12.7 to 31.8 microns). A minimum of twenty to thirty minutes and no more than one hour of time was allowed to elapse before applying a PPG Industries, Inc. global sealer D 839 over each composition. The sealer was mixed and applied as a wet-on-wet sealer to approximately 1.0 to 2.0 mils (25.4 to 50.8 microns) of paint and allowed to flash forty-five minutes before applying base coat. Deltron DBC base coat, commercially available from PPG Industries, Inc., was applied over the sealer in two coats with five to ten minutes flash time between coats to a film build thickness of approximately 0.5 mils (12.7 microns). The base coat was allowed approximately fifteen minutes time to flash before applying D893 Global clear coat, commercially available from PPG Industries, Inc., in two coats with five to ten minutes to flash between coats to a film build of 2.00 to 3.00 mils (50.8 to 76.2 microns). Sealer, base coat, and clear coat were mixed as the procedure for these products recommended by PPG Industries, Inc. Salt spray resistance was tested as described in ASTM B 117. Panels removed from salt spray testing after 500 and 1000 hours were measured for scribe creep across the scribe. Scribe creep values were reported as an average of six (6) measurements. Results are illustrated in Tables 5 and 6, with lower value indicated better corrosion resistance results.

TABLE 5
Salt Spray Resistance after 500 hours

| | | | | | | | Ex. | Ex. |
|---|---|---|---|---|---|---|---|---|
| Substrate | Ex. 1 | Ex. 2 | Ex. 3 | Ex. 4 | Ex. 5 | Ex. 6 | 7¹⁸ | 8¹⁹ |
| Cold Rolled | 24.5 | 1.7 | 0.8 | 7.1 | 16.3 | 13.5 | 24.1 | 5.8 |
| Steel | | | | | | | | |
| (APR10288) | | | | | | | | |
| G-60 | 0 | 0 | 0 | 0 | 0 | 0 | 0.2 | 0 |
| Galvanized | | | | | | | | |
| (APR18661) | | | | | | | | |
| Aluminum | 0 | 12.3 | 3.8 | 6.8 | 8.8 | 2.8 | 0.8 | 0 |
| (APR21047) | | | | | | | | |

¹⁸D-831 commercially available from PPG Industries, Inc., Pittsburgh, PA.
¹⁹D8099 Fast Drying-Anti-Corrosion Etch Primer commercially available from PPG Industries, Inc., Pittsburgh, PA.

TABLE 6
Salt Spray Resistance after 1000 hours

| | | | | | | | Ex. | Ex. |
|---|---|---|---|---|---|---|---|---|
| Substrate | Ex. 1 | Ex. 2 | Ex. 3 | Ex. 4 | Ex. 5 | Ex. 6 | 7¹⁸ | 8¹⁹ |
| Cold Rolled | 29.8 | 1.1 | 15.7 | 17.6 | 26.3 | 25.8 | 22.4 | 8.8 |
| Steel | | | | | | | | |
| (APR10288) | | | | | | | | |
| G-60 | 4.5 | 0 | 3 | 0 | 7.2 | 22.7 | 2.8 | 0 |
| Galvanized | | | | | | | | |
| (APR18661) | | | | | | | | |
| Aluminum | 0 | 12.5 | 25.8 | 10.5 | 19 | 5.4 | 2.3 | 0 |
| (APR21047) | | | | | | | | |

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A coating composition comprising:
(a) a film-forming resin, and
(b) ultrafine corrosion resisting particles comprising ultrafine unsaturated transition metal oxide particles deposited on and/or within an ultrafine support.

2. The coating composition of claim 1, wherein the composition is substantially free of chromium containing material.

3. The coating composition of claim 1, wherein the transition metal comprises Ti, V, Mn, Fe, Co, Ni, Cu, Nb, Tc, Pd, Re, Os, Ir, Pt, and/or Au.

4. The coating composition of claim 3, wherein the transition metal comprises Mn.

5. The coating composition of claim 1, wherein the unsaturated transition metal oxide is selected from the group consisting of TiO, Ti₂O₃, VO, V₂O₃, VO₂, MnO, Mn₂O₃, MnO₂, FeO, CoO, NiO, Cu₂O, Nb₂O₃, TcO₂, TcO₃, PdO, ReO₂, ReO₃, Ir₂O₃, PtO, Au₂O, and a combination thereof.

6. The coating composition of claim 1, wherein the support comprises amorphous silica.

7. The coating composition of claim 6, wherein the support has an average primary particle size of no more than 50 nanometers and the ultrafine unsaturated transition metal oxide particles have an average primary particle size of no more than 20 nanometers.

8. The coating composition of claim 1, wherein the ultrafine corrosion resisting particles have an average B.E.T. specific surface area of 80 to 350 square meters per gram.

9. The coating composition of claim 1, wherein the film-forming resin comprises a thermosetting and/or thermoplastic film-forming resin.

10. The coating composition of claim 1, wherein the film-forming resin comprises a polyvinyl polymer.

11. The coating composition of claim 1, wherein the composition is a metal substrate primer composition and/or metal substrate pretreatment composition.

12. A substrate at least partially coated with a coating deposited from the coating composition of claim 1.

13. The substrate of claim 12, wherein the substrate comprises steel, aluminum, aluminum alloys, zinc-aluminum alloys, and aluminum plated steel.

14. The coating composition of claim 1, further comprising an adhesion promoting component.

15. The coating composition of claim 14, wherein the adhesion promoting component comprises a free acid, a metal phosphate, an organophosphate, an organophosphonate, and/or a phosphatized epoxy resin.

16. A multi-component composite coating comprising at least one coating layer deposited from the coating composition of claim 1.

17. A method for making a coating composition comprising combining ultrafine unsaturated transition metal oxide particles with a film-forming resin, wherein the particles are not coated with a layer of organic molecules prior to the combining step.

18. The method of claim 17, wherein the ultrafine, unsaturated, and stoichiometric transition metal oxide particles are deposited on and/or within an ultrafine support.

19. The method of claim 17, wherein the transition metal comprises Mn.

20. The method of claim 18, wherein the support comprises amorphous silica.

21. The method of claim 18, wherein the support has an average primary particle size of no more than 50 nanometers and the ultrafine unsaturated transition metal oxide particles have an average primary particle size of no more than 20 nanometers.

22. The method of claim 17, wherein the film-forming resin comprises a thermosetting and/or thermoplastic film-forming resin.
